(19) United States
(12) Patent Application Publication
(10) Pub. No.: US 2022/0358304 A1
(43) Pub. Date: Nov. 10, 2022

(54) ALL-SCREEN OPTICAL FINGERPRINTING

(71) Applicant: QUALCOMM Incorporated, San Diego, CA (US)

(72) Inventor: Russell Wayne GRUHLKE, San Jose, CA (US)

(21) Appl. No.: 17/302,542

(22) Filed: May 5, 2021

(51) Int. Cl. G06K 9/00

(52) U.S. Cl. CPC G06K 9/0002; G06K 9/00093

(57) ABSTRACT

Some disclosed methods involve receiving, by a control system, touch sensor signals from a touch sensor system indicating a touch of a target object in a target object touch area and controlling, by the control system and responsive to the touch sensor signals, a plurality of display pixels of a display stack to illuminate the target object touch area. Such methods may involve receiving, by the control system and from an optical sensor system, optical sensor signals corresponding to light transmitted from the plurality of display pixels, reflected or scattered from the target object, transmitted through a plurality of display stack apertures, directed by a light guide system and received by an optical sensor system. Such methods may involve performing, by the control system, an authentication process based, at least in part, on the optical sensor signals.

### TECHNICAL FIELD

This disclosure relates generally to optical sensor devices and related methods, including but not limited to optical fingerprint sensor systems and methods for using such systems.

### DESCRIPTION OF THE RELATED TECHNOLOGY

Fingerprint sensor systems are commonly featured in a variety of devices. Biometric authentication, including but not limited to fingerprint-based authentication, can be an important feature for controlling access to devices, secured areas, etc. Although some existing fingerprint sensor systems provide satisfactory performance under some conditions, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus. According to some examples, the apparatus includes a touch sensor system. In some examples, the apparatus includes a display stack residing in a display area. In some examples, the display stack includes display pixels and a plurality of display stack apertures. According to some examples, the apparatus includes a transparent cover proximate a first side of the display stack and a light guide system proximate a second and opposing side of the display stack. In some examples, the light guide system is configured to receive light transmitted though the display stack apertures and to direct received light in two or more directions. According to some examples, the apparatus includes an optical sensor system including one or more linear arrays of optical sensor pixels. In some examples, each of the one or more linear arrays of optical sensor pixels resides proximate a corresponding side of the light guide system. In some examples, the plurality of display pixels may include one or more light-emitting diode pixels, one or more organic light-emitting diode pixels and/or one or more liquid crystal display pixels.

According to some examples, the apparatus includes a control system configured for communication with (e.g. electrically or wirelessly coupled to) the touch sensor system, the optical sensor system and the display stack. In some examples, the control system may include a memory, whereas in other examples the control system may be configured for communication with a memory that is not part of the control system. According to some examples, the apparatus may be integrated into a mobile device. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

According to some examples, the control system may be configured to receive touch sensor signals from the touch sensor system indicating a touch of a target object in a target object touch area. In some examples, the control system may be configured to control, responsive to the touch sensor signals, a plurality of display pixels to illuminate the target object touch area. According to some examples, the control system may be configured to receive, from the optical sensor system, optical sensor signals corresponding to light transmitted from the plurality of display pixels, reflected or scattered from the target object, transmitted through the display stack apertures, directed by the light guide system and received by the optical sensor system. In some examples, the control system may be configured to perform an authentication process based, at least in part, on the optical sensor signals.

In some implementations, the control system may be further configured to determine a fingerprint image based, at least in part, on the optical sensor signals. In some such implementations, the control system may be configured to determine the fingerprint image based, at least in part, on a process of correlating local intensity maxima of the optical sensor signals with fingerprint image locations. In some such implementations, the process of correlating local intensity maxima of the optical sensor signals with fingerprint image locations may involve applying a backwards propagation algorithm. Some such implementations also may include an angular decoder residing between the light guide system and each of the one or more linear arrays of optical sensor pixels. In some such examples, the angular decoder may include opaque sections and transparent sections. In some such examples, the process of correlating local intensity maxima of the optical sensor signals with fingerprint image locations may involve applying the backwards propagation algorithm according to transparent section locations and local intensity maxima locations corresponding to the transparent section locations.

In some examples, the control system may be configured to extract fingerprint features from the fingerprint image. In some such examples, the authentication process may involve comparing currently-obtained fingerprint features with fingerprint features obtained during an enrollment process. The fingerprint features may, for example, include fingerprint minutiae, keypoints and/or sweat pores.

In some implementations, the optical sensor system may include a first linear array of optical sensor pixels and a second linear array of optical sensor pixels. In some such implementations, the first linear array of optical sensor pixels may reside proximate a first side of the light guide system and the second linear array of optical sensor pixels may reside proximate a second side of the light guide system opposite the first side. In some such implementations, the optical sensor system may include a third linear array of optical sensor pixels and a fourth linear array of optical sensor pixels. In some such implementations, the third linear array of optical sensor pixels may reside proximate a third side of the light guide system and the fourth linear array of optical sensor pixels may reside proximate a fourth side of the light guide system opposite the third side.

In some implementations, the first linear array of optical sensor pixels may reside proximate a first side of the light guide system and the second linear array of optical sensor pixels may reside proximate a second side of the light guide system adjacent the first side. In some examples, each of the one or more linear arrays of optical sensor pixels resides proximate a corresponding side of the display area.

According to some implementations, the light guide system may include a holographic volume grating configured to direct the received light in the two or more directions, a surface relief grating configured to direct the received light in the two or more directions and/or reflective facets configured to direct the received light in the two or more directions.

In some implementations, the plurality of display stack apertures may be configured for collimating the light transmitted through the plurality of display stack apertures. According to some implementations, the display stack apertures may be surrounded by light-absorbing sidewalls.

Other innovative aspects of the subject matter described in this disclosure may be implemented in a method. In some examples, the method may involve receiving, by a control system, touch sensor signals from a touch sensor system indicating a touch of a target object in a target object touch area. According to some examples, the method may involve controlling, by the control system and responsive to the touch sensor signals, a plurality of display pixels of a display stack to illuminate the target object touch area. In some examples, the method may involve receiving, by the control system and from an optical sensor system, optical sensor signals corresponding to light transmitted from the plurality of display pixels, reflected or scattered from the target object, transmitted through a plurality of display stack apertures, directed by a light guide system and received by an optical sensor system. According to some examples, the method may involve performing, by the control system, an authentication process based, at least in part, on the optical sensor signals. In some examples, the method may involve collimating light transmitted through the plurality of display stack apertures.

In some examples, the method may involve determining, by the control system, a fingerprint image based, at least in part, on the optical sensor signals. According to some examples, the method may involve extracting fingerprint features from the fingerprint image. In some such examples, the authentication process may involve comparing currently-obtained fingerprint features with fingerprint features obtained during an enrollment process. According to some examples, determining the fingerprint image may involve a process of correlating local intensity maxima of the optical sensor signals with fingerprint image locations. In some examples, the process of correlating local intensity maxima of the optical sensor signals with fingerprint image locations may involve applying a backwards propagation algorithm. In some instances, the process of correlating local intensity maxima of the optical sensor signals with fingerprint image locations may involve applying the backwards propagation algorithm according to transparent section locations of an angular decoder residing between the light guide system and each of one or more linear arrays of optical sensor pixels. In some such examples, the process of correlating local intensity maxima of the optical sensor signals with fingerprint image locations may involve applying the backwards propagation algorithm according to local intensity maxima locations corresponding to the transparent section locations.

In some instances, the light guide system may receive light transmitted though the display stack apertures and may direct received light in two or more directions. According to some examples, the optical sensor signals may be received from one or more linear arrays of optical sensor pixels of the optical sensor system. In some implementations, each of the one or more linear arrays of optical sensor pixels may reside proximate a corresponding side of the light guide system.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon. For example, the software may include instructions for controlling one or more devices to perform a method.

In some examples, the method may involve receiving, by a control system, touch sensor signals from a touch sensor system indicating a touch of a target object in a target object touch area. According to some examples, the method may involve controlling, by the control system and responsive to the touch sensor signals, a plurality of display pixels of a display stack to illuminate the target object touch area. In some examples, the method may involve receiving, by the control system and from an optical sensor system, optical sensor signals corresponding to light transmitted from the plurality of display pixels, reflected or scattered from the target object, transmitted through a plurality of display stack apertures, directed by a light guide system and received by an optical sensor system. According to some examples, the method may involve performing, by the control system, an authentication process based, at least in part, on the optical sensor signals. In some examples, the method may involve collimating light transmitted through the plurality of display stack apertures.

In some examples, the method may involve determining, by the control system, a fingerprint image based, at least in part, on the optical sensor signals. According to some examples, the method may involve extracting fingerprint features from the fingerprint image. In some such examples, the authentication process may involve comparing currently-obtained fingerprint features with fingerprint features obtained during an enrollment process. According to some examples, determining the fingerprint image may involve a process of correlating local intensity maxima of the optical sensor signals with fingerprint image locations. In some examples, the process of correlating local intensity maxima of the optical sensor signals with fingerprint image locations may involve applying a backwards propagation algorithm. In some instances, the process of correlating local intensity maxima of the optical sensor signals with fingerprint image locations may involve applying the backwards propagation algorithm according to transparent section locations of an angular decoder residing between the light guide system and each of one or more linear arrays of optical sensor pixels. In some such examples, the process of correlating local intensity maxima of the optical sensor signals with fingerprint image locations may involve applying the backwards propagation algorithm according to local intensity maxima locations corresponding to the transparent section locations.

In some instances, the light guide system may receive light transmitted though the display stack apertures and may direct received light in two or more directions. According to some examples, the optical sensor signals may be received from one or more linear arrays of optical sensor pixels of the optical sensor system. In some implementations, each of the one or more linear arrays of optical sensor pixels may reside proximate a corresponding side of the light guide system.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 is a block diagram that shows example components of an apparatus according to some disclosed implementations.

FIG. 2 shows a cross-section though one example of the apparatus of FIG. 1.

FIG. 3A shows a top view of some examples of reflective facets that may be incorporated into a light-turning film.

FIG. 3B shows a top view of one example of the apparatus of FIG. 2.

FIG. 4 shows a top view of another example of the apparatus of FIG. 2.

FIG. 5A shows a top view of another example of the apparatus of FIG. 2.

FIG. 5B is an enlarged view of a portion of FIG. 5A.

FIG. 5C shows an example of a line determined by a backwards propagation algorithm.

FIG. 5D shows an example of estimating a fingerprint point location according to a backwards propagation algorithm.

FIG. 6 is a flow diagram that provides examples of operations according to some disclosed methods.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The use of fingerprint sensors for authentication is now commonplace. (As used herein, the term “finger” may refer to any digit, including a thumb. Accordingly, a thumbprint will be considered a type of “fingerprint.”) In some examples, a control system of an apparatus will obtain a target object location (e.g., a digit location) for fingerprint sensor scanning via input from a touch sensor system.

There are severe technological constraints for fingerprint sensors built into or under a display. Because of these constraints, only ultrasonic and optical fingerprint technologies are used for in-display or under-display implementations. Ultrasonic fingerprint sensors provide some advantages, such as three-dimensional imaging capabilities that provide greater anti-spoofing capability than the two-dimensional images provided by optical fingerprint sensors. However, ultrasonic fingerprint sensors tend to be relatively more expensive than optical fingerprint sensors and may not be as effective in some conditions. Due in part to the relatively high cost of ultrasonic fingerprint sensors, the active area of an under-display ultrasonic fingerprint sensor is usually about as large as a thumb surface. However, some currently-deployed optical fingerprint sensors extend under most or all of the display area.

Some disclosed implementations provide optical sensor functionality throughout most or all of a device display area (e.g., a display area of a mobile device). According to some examples, the apparatus includes a control system, a touch sensor system, an optical sensor system and a display stack that includes display pixels and a plurality of display stack apertures. According to some examples, the apparatus includes a transparent cover proximate a first side of the display stack and a light guide system proximate a second and opposing side of the display stack. In some examples, the light guide system is configured to receive light transmitted though the display stack apertures and to direct received light in two or more directions. According to some examples, the optical sensor system includes a linear array of optical sensor pixels extending along one or more sides of the light guide system.

In some examples, the control system may be configured to receive touch sensor signals from the touch sensor system indicating a touch of a target object in a target object touch area and to control, responsive to the touch sensor signals, a plurality of display pixels to illuminate the target object touch area. The control system may be configured to receive, from the optical sensor system, optical sensor signals corresponding to light transmitted from the plurality of display pixels, reflected or scattered from the target object, transmitted through the display stack apertures, directed by the light guide system and received by the optical sensor system. The control system may be configured to perform an authentication process based, at least in part, on the optical sensor signals.

Particular implementations of the subject matter described in this disclosure may be implemented to realize one or more of the following potential advantages. Some disclosed devices provide under-display optical fingerprint sensor functionality in most or all of the device display area. The fingerprint sensor systems of such devices are less expensive than ultrasonic fingerprint sensor systems that extend throughout most or all of the device display area. Some disclosed devices provide under-display optical fingerprint sensor functionality in most or all of the device display area without requiring optical sensor pixels to be deployed throughout the entire device display area. These implementations can provide cost savings relative to previously-deployed under-display optical fingerprint sensors.

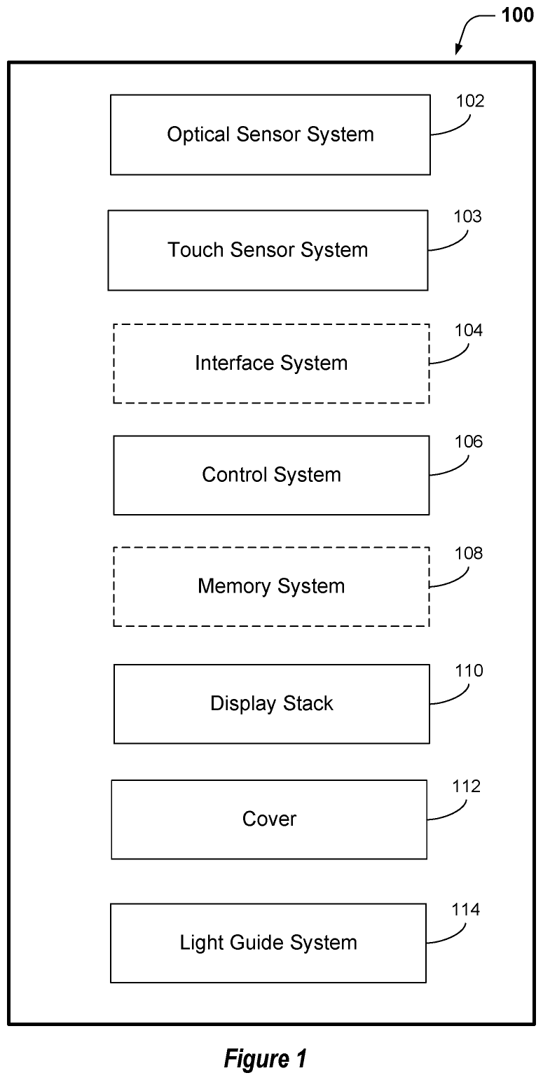

FIG. 1 is a block diagram that shows example components of an apparatus according to some disclosed implementations. In this example, the apparatus 100 includes an optical sensor system 102, a touch sensor system 103, a control system 106, a display stack 110, a cover 112 and a light guide system 114. Some implementations may include an interface system 104 and/or a memory system 108.

According to some examples, the optical sensor system 102 may include one or more linear arrays of optical sensor pixels. In some examples, each of the one or more linear arrays of optical sensor pixels may reside proximate (e.g., adjacent to) a corresponding side of the light guide system 114. For example, each of the one or more linear arrays of optical sensor pixels may extend along one or more corresponding lateral edges of the light guide system 114. In some implementations, the optical sensor system 102 may include one or more linear arrays of active pixel sensors, such as complementary metal-oxide-semiconductor (CMOS) sensors. According to some implementations, the optical sensor system 102 may include one or more linear arrays of charge-coupled device (CCD) image sensors. According to some examples, the optical sensor pixels are in a size range of 10 microns to 50 microns. For examples, each of the optical sensor pixels may have the shape of rectangular prisms having sides in the range from 10 microns to 50 microns. In some examples, the optical sensor pixels may have an inter-pixel spacing in the range of 5 microns to 50 microns. For example, the inter-pixel spacing may be 5 microns or less, 10 microns or less, 15 microns or less, 20 microns or less, 25 microns or less, etc.

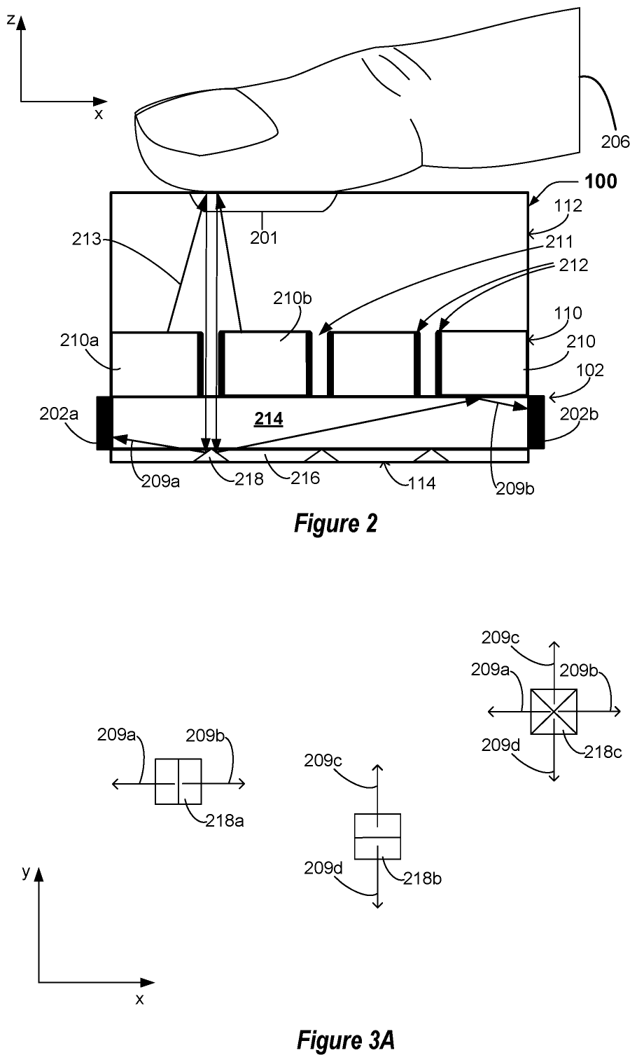

Various examples of configurations for the optical sensor system 102 are shown in FIGS. 2-5D and are described below. In some examples, the optical sensor system 102 includes at least a first linear array of optical sensor pixels and a second linear array of optical sensor pixels. In some such examples, the first linear array of optical sensor pixels resides proximate a first side of the light guide system 114 and the second linear array of optical sensor pixels resides proximate a second side of the light guide system 114 that is opposite from the first side. In some implementations, the second linear array of optical sensor pixels resides proximate a second side of the light guide system 114 that is adjacent to the first side. In some examples, the optical sensor system 102 includes a third linear array of optical sensor pixels and a fourth linear array of optical sensor pixels. In some implementations, the third linear array of optical sensor pixels resides proximate a third side of the light guide system 114 and the fourth linear array of optical sensor pixels resides proximate a fourth side of the light guide system 114 that is opposite the third side. According to some examples, each of the one or more linear arrays of optical sensor pixels resides proximate a corresponding side of the display area.

The touch sensor system 103 may be, or may include, a resistive touch sensor system, a surface capacitive touch sensor system, a projected capacitive touch sensor system, a surface acoustic wave touch sensor system, an infrared touch sensor system, or any other suitable type of touch sensor system. In some implementations, the area of the touch sensor system 103 may extend over most or all of a display portion of the display stack 110.

Some implementations of the apparatus 100 may include an interface system 104. In some examples, the interface system 104 may include a wireless interface system. In some implementations, the interface system 104 may include a user interface system, one or more network interfaces, one or more interfaces between the control system 106 and the optical sensor system 102, one or more interfaces between the control system 106 and the touch sensor system 103, one or more interfaces between the control system 106 and the memory system 108, one or more interfaces between the control system 106 and the display stack 110, and/or one or more interfaces between the control system 106 and one or more external device interfaces (e.g., ports or applications processors).

The interface system 104 may be configured to provide communication (which may include wired or wireless communication, electrical communication, radio communication, etc.) between components of the apparatus 100. In some such examples, the interface system 104 may be configured to provide communication between the control system 106 and the optical sensor system 102. According to some such examples, the interface system 104 may couple at least a portion of the control system 106 to the optical sensor system 102 and the interface system 104 may couple at least a portion of the control system 106 to the touch sensor system 103, e.g., via electrically conducting material (e.g., via conductive metal wires or traces. According to some examples, the interface system 104 may be configured to provide communication between the apparatus 100 and other devices and/or human beings. In some such examples, the interface system 104 may include one or more user interfaces. The interface system 104 may, in some examples, include one or more network interfaces and/or one or more external device interfaces (such as one or more universal serial bus (USB) interfaces or a serial peripheral interface (SPI)).

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc. In this example, the control system 106 is configured for communication with, and for controlling, the optical sensor system 102, the touch sensor system 103 and the display stack 110. According to some examples, the control system 106 may include a dedicated component for controlling the optical sensor system 102, a dedicated component for controlling the touch sensor system 103 and/or a dedicated component for controlling the display stack 110. If the apparatus includes a memory system 108 that is separate from the control system 106, the control system 106 also may be configured for communication with the memory system 108. In some implementations, functionality of the control system 106 may be partitioned between one or more controllers or processors, such as between a dedicated sensor controller and an applications processor of a mobile device.

In some examples, the memory system 108 may include one or more memory devices, such as one or more RAM devices, ROM devices, etc. In some implementations, the memory system 108 may include one or more computer-readable media, storage media and/or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

In this implementation, the apparatus 100 includes a display system. According to this example, the display system includes layers, which may be referred to collectively as a display stack 110, residing in a display area of the display system. In some examples, the display stack 110 may be, or may include, a light-emitting diode (LED) display stack, such as an organic light-emitting diode (OLED) display stack. In some examples, the display stack 110 may include liquid crystal display (LCD) pixels. In some disclosed implementations, the display stack includes display pixels and a plurality of display stack apertures. The display stack apertures may be located between some or all of the display pixels. In some examples, the display stack apertures may be configured for collimating light that is transmitted through the display stack apertures. In some such examples, the display stack apertures may be surrounded by light-absorbing sidewalls.

According to this example, the apparatus 100 includes a cover 112. In some implementations, the cover 112 includes a transparent portion, such as a “cover glass,” proximate (e.g., extending over) the display stack 110. A cover glass generally includes transparent material, which may be a type of glass, hard plastic, etc.

In this example, the apparatus 100 includes a light guide system 114. In some instances, a transparent portion of the cover 112 is proximate a first side of the display stack 110 and the light guide system 114 is proximate a second and opposing side of the display stack 110. According to some examples, the light guide system 114 may be configured to receive light transmitted though the display stack apertures and to direct received light in two or more directions. In some examples, the light guide system 114 may include an optical light guide and a light-turning film. According to some implementations, the light guide system 114 (e.g., a light-turning film portion of the light guide system 114) may include a holographic volume grating configured to direct the received light in the two or more directions, a surface relief grating configured to direct the received light in the two or more directions and/or reflective facets configured to direct the received light in the two or more directions.

The apparatus 100 may be used in a variety of different contexts, some examples of which are disclosed herein. For example, in some implementations a mobile device may include at least a portion of the apparatus 100. In some implementations, a wearable device may include at least a portion of the apparatus 100. The wearable device may, for example, be a bracelet, an armband, a wristband, a ring, a headband or a patch. In some implementations, the control system 106 may reside in more than one device. For example, a portion of the control system 106 may reside in a wearable device and another portion of the control system 106 may reside in another device, such as a mobile device (e.g., a smartphone). The interface system 104 also may, in some such examples, reside in more than one device.

FIG. 2 shows a cross-section though one example of the apparatus of FIG. 1. As with other disclosed implementations, the types, numbers and arrangements of elements, as well as the dimensions of elements, that are shown in FIG. 2 are merely examples. For instance, the dimensions of the display pixels 210 in an actual device would generally be much smaller, relative to the size of the finger 206, than indicated in FIG. 2. In this example, the apparatus 100 includes a display stack 110 that includes display pixels 210 and a plurality of display stack apertures 211. According to some examples, each of the display stack apertures 211 may be a cylindrical aperture having a circular or oval cross section. In other examples, the display stack apertures 211 may have other shapes, such as square or rectangular cross-sectional shapes.

Although not shown in FIG. 2, according to this example the apparatus 100 includes a touch sensor system and a control system, which are instances of the touch sensor system 103 and the control system 106 that are described above with reference to FIG. 1. In this example, the control system has received touch sensor signals from the touch sensor system indicating a touch of a target object (the finger 206, in this example) in a target object touch area 201. According to this example, in response to the touch sensor signals the control system is controlling a plurality of display pixels (including at least the display pixels 210a and 210b) to illuminate the target object touch area 201. Here, the light 213 is transmitted from the plurality of display pixels, reflected or scattered from the finger 206 and transmitted through the display stack apertures 211.

In this implementation, the display stack apertures 211 are configured for collimating the light 213 that has been reflected or scattered from the target object and transmitted through the display stack apertures 211. According to this example, the display stack apertures 211 are surrounded by light-absorbing sidewalls 212. Display stack apertures 211 having light-absorbing sidewalls 212 can provide satisfactory collimation of light. In this example, the collimated light that is transmitted through the display stack apertures 211 travels in a direction that is parallel to the z axis, or substantially parallel to the z axis (e.g., +/−2 degrees, +/−4 degrees, +/−6 degrees, +/−8 degrees, +/−10 degrees, etc.). In some examples, the light-absorbing sidewalls 212 may be formed by adding light-absorbing material, such as black ink, to the display stack apertures 211. In other examples, the some or all of the display stack structure between the display pixels 210 may be formed of light-absorbing material. According to some such examples, when the display stack apertures 211 are made through this light-absorbing material, the display stack apertures 211 have light-absorbing sidewalls 212 formed of the light-absorbing material. In other examples, the display stack apertures 211 may not include light-absorbing material in the sidewalls. According to some such examples, the sidewalls may be sufficiently rough to cause scattering of light impinging on the sidewalls. Such scattering tends to prevent light impinging on the sidewalls from propagating through the display stack apertures 211.

According to this example, at least some of the light 213 that has been reflected or scattered from the finger 206 and transmitted through the display stack apertures 211 is directed by the light guide system 114 and received by the optical sensor system 102. According to this example, the light guide system 114 includes an optical light guide 214 and a light-turning film 216. In this particular implementation, the light-turning film 216 includes reflective facets 218 that are configured to reflect received light (e.g., light 213 that has been received via the display stack apertures 211) into the optical light guide 214, which transmits the reflected light to the optical sensor system 102. According to this example, the optical sensor system 102 includes linear arrays of optical sensor pixels 202a and 202b, each of which resides along opposite sides of the light guide system 114. Here, a reflective facet 218 is shown reflecting light ray 209a towards the linear array of optical sensor pixels 202a and reflecting light ray 209b towards the linear array of optical sensor pixels 202b. In other implementations, the optical sensor system 102 may include arcuate arrays of optical sensor pixels and/or other arrays of optical sensor pixels that are not straight lines.

According to some examples, a control system of the apparatus 100 may be configured to receive, from the optical sensor system 102, optical sensor signals corresponding to light transmitted from the plurality of display pixels 210, reflected or scattered from the finger 206, transmitted through the display stack apertures 211, directed by the light guide system 114 and received by the optical sensor system 102. In some such examples, the control system may be configured to perform an authentication process based, at least in part, on the optical sensor signals.

According to some such implementations, the control system may be configured to determine a fingerprint image based, at least in part, on the optical sensor signals. In some such examples, the control system may be configured to determine the fingerprint image based, at least in part, on a process of correlating local intensity maxima of the optical sensor signals with fingerprint image locations. In some implementations, the control system may be configured to extract fingerprint features from the fingerprint image. The fingerprint features may, for example include fingerprint minutiae, keypoints and/or sweat pores. The authentication process may involve comparing currently-obtained fingerprint features with fingerprint features obtained during an enrollment process.

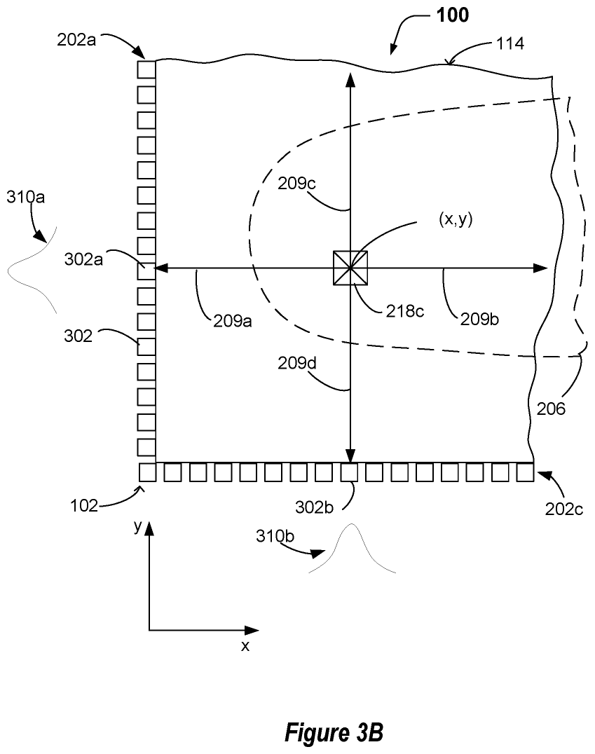

FIG. 3A shows a top view of some examples of reflective facets that may be incorporated into a light-turning film. In this example, the perspective of view is along the z axis that is shown in FIG. 2. According to this example, each of the reflective facets 218a, 218band 218c is configured to reflect light in two or more directions, which are opposite and/or orthogonal directions in these examples. In this example, the reflective facet 218a is configured to reflect the light rays 209a and 209b in opposite directions that are parallel to, or substantially parallel to, the x axis (e.g., +/−2 degrees, +/−4 degrees, +/−6 degrees, +/−8 degrees, +/−10 degrees, etc.). According to this example, the reflective facet 218b is configured to reflect the light rays 209c and 209d in opposite directions that are parallel to, or substantially parallel to, the y axis (e.g., +/−2 degrees, +/−4 degrees, +/−6 degrees, +/−8 degrees, +/−10 degrees, etc.). In this example, the reflective facet 218c is configured to reflect the light rays 209a and 209b in opposite directions that are parallel to, or substantially parallel to, the x axis and is also configured to reflect the light rays 209c and 209d in opposite directions that are parallel to, or substantially parallel to, the y axis.

In other examples, a light-turning film 216 may include reflective facets 218 having other geometries. Alternatively, or additionally, the light-turning film 216 may include a holographic volume grating that is configured to direct received light in two or more directions. In some implementations, a light-turning film 216 may include a surface relief grating configured to direct the received light in the two or more directions.

FIG. 3B shows a top view of one example of the apparatus of FIG. 2. In this example, the perspective of view is along the z axis that is shown in FIG. 2. According to this example, the dashed outline of the finger 206, which is shown in FIG. 2, is also shown in FIG. 3B. As with other disclosed implementations, the types, numbers and arrangements of elements, as well as the dimensions of elements, that are shown in FIG. 3B are merely examples. For instance, the dimensions of the optical sensor pixels 302 in an actual device would generally be much smaller, relative to the size of the finger 206, than indicated in FIG. 3B.

Here, only a portion of the apparatus 100 and a portion of the light guide system 114 is shown. For the sake of simplicity, only a single reflective facet, the reflective facet 218a, is shown in FIG. 3B.

In this example, light from a plurality of display pixels 210 has reflected or scattered from a fingerprint area of the finger 206 at a point (x,y) (which may be referred to herein as a “fingerprint point”), has been transmitted through one of the display stack apertures 211, has been directed by directed by the light guide system 114 and has been received by the optical sensor system 102. According to this example, the optical sensor system 102 includes at least the linear array of optical sensor pixels 202a along one side of the light guide system 114 and the linear array of optical sensor pixels 202c along a second and adjacent side of the light guide system 114.

FIG. 3B shows some advantages of having the light guide system 114 configured to direct light in predetermined and predictable directions. In this example, as in FIG. 3A, the reflective facet 218c is configured to reflect the light rays 209a and 209b in opposite directions that are parallel to, or substantially parallel to, the x axis and is also configured to reflect the light rays 209c and 209d in opposite directions that are parallel to, or substantially parallel to, the y axis. Accordingly, the (x,y) location of the fingerprint point from which the light reflected may be determined according to the locations of the optical sensor pixels 302 that detect the light rays 209a and 209d.

In this example, the x coordinate of the fingerprint point from which the light reflected corresponds with the x coordinate of the optical sensor pixel 302b and the y coordinate of the fingerprint point from which the light reflected corresponds with the y coordinate of the optical sensor pixel 302a. According to this example, the optical sensor pixel 302a may be identified as having a y coordinate corresponding to the y coordinate of the fingerprint point from which the light reflected according to a local intensity maximum of optical sensor signals, as shown by the graph of optical sensor signal intensity 310a. Likewise, the optical sensor pixel 302b may be identified as having an x coordinate corresponding to the x coordinate of the fingerprint point from which the light reflected according to another local intensity maximum of optical sensor signals, as shown by the graph of optical sensor signal intensity 310b.

In some examples, a control system of the apparatus 100 may be configured to sum the optical sensor signals received from the optical sensor pixels 302a and 302b, and to assign the corresponding summed signal to an (x,y) coordinate of a fingerprint image corresponding with the fingerprint point from which the light reflected. According to some implementations, the process used to obtain the summed signal of the fingerprint image for the one fingerprint point shown in FIG. 3B (or a similar process) may be used to obtain optical sensor signals corresponding to each (x,y) coordinate of a fingerprint image corresponding to an entire fingerprint area, such as the entire target object touch area 201 of the finger 206 that is shown in FIG. 2.

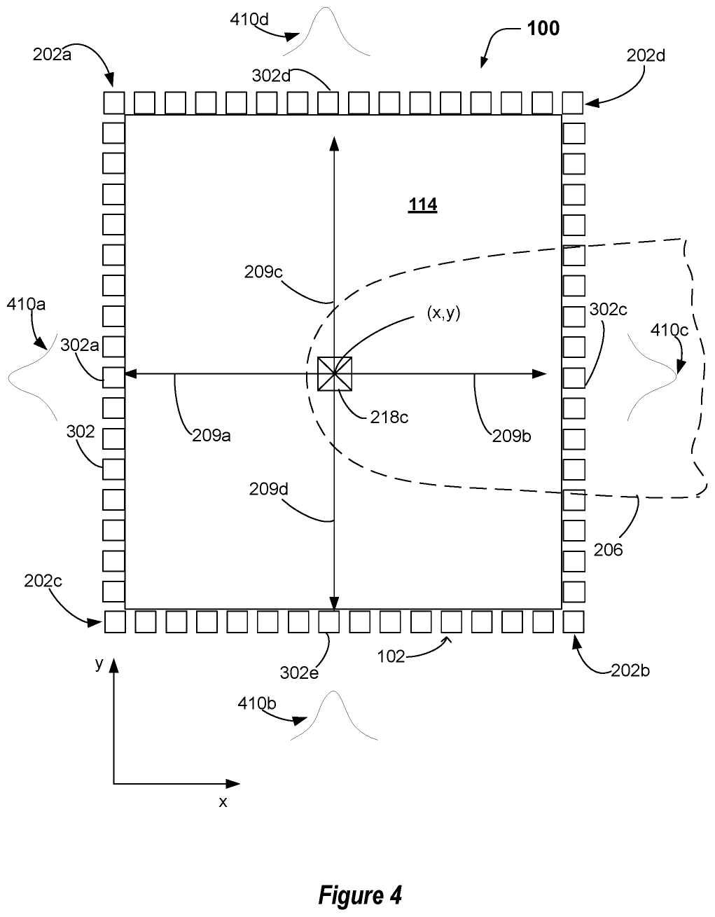

FIG. 4 shows a top view of another example of the apparatus of FIG. 2. In this example, the perspective of view is along the z axis that is shown in FIG. 2. As with other disclosed implementations, the types, numbers and arrangements of elements, as well as the dimensions of elements, that are shown in FIG. 4 are merely examples.

In this example, light from a plurality of display pixels 210 has reflected or scattered from a fingerprint point (x,y), has been transmitted through one of the display stack apertures 211, has been directed by directed by the light guide system 114 and has been received by the optical sensor system 102. As in FIG. 3B, in this example the optical sensor system 102 includes the linear array of optical sensor pixels 202a along one side of the light guide system 114 and the linear array of optical sensor pixels 202c along a second and adjacent side of the light guide system 114. However, according to this example, the optical sensor system 102 also includes the linear array of optical sensor pixels 202b along a third side of the light guide system 114 that is opposite the side of the light guide system 114 along which the linear array of optical sensor pixels 202a resides. Here, the optical sensor system 102 also includes the linear array of optical sensor pixels 202d along a fourth side of the light guide system 114 that is opposite the side of the light guide system 114 along which the linear array of optical sensor pixels 202c resides.

FIG. 4 shows some advantages of having the light guide system 114 configured to direct light in predetermined and predictable directions, as well as advantages of having arrays of optical sensor pixels on all sides of the light guide system 114. In this example, as in FIG. 3A, the reflective facet 218c is configured to reflect the light rays 209a and 209b in opposite directions that are parallel to, or substantially parallel to, the x axis and is also configured to reflect the light rays 209c and 209d in opposite directions that are parallel to, or substantially parallel to, the y axis. Accordingly, the (x,y) location of the fingerprint point from which the light reflected may be determined according to the locations of the optical sensor pixels 302 that detect the light rays 209a, 209b, 209c and 209d.

In this example, the x coordinate of the fingerprint point from which the light reflected corresponds with the x coordinates of the optical sensor pixels 302e and 302d, and the y coordinate of the fingerprint point from which the light reflected corresponds with the y coordinates of the optical sensor pixels 302a and 302c. According to this example, the optical sensor pixels 302a and 302c may be identified as having a y coordinate corresponding to the y coordinate of the fingerprint point from which the light reflected according to local intensity maxima of optical sensor signals from two opposing sides of the light guide system 114, as shown by the graphs of optical sensor signal intensity 410a and 410c. Likewise, the optical sensor pixels 302e and 302d may be identified as having an x coordinate corresponding to the x coordinate of the fingerprint point from which the light reflected according to local intensity maxima of optical sensor signals from two opposing sides of the light guide system 114, as shown by the graphs of optical sensor signal intensity 410b and 410d. With this configuration of the light guide system, obtaining local intensity maxima of optical sensor signals from two opposing sides of the light guide system 114 provides redundancy that can result in greater accuracy in estimating the (x,y) coordinates of the fingerprint point from which the light reflected.

According to some examples, the optical sensor pixels corresponding to local intensity maxima produced by reflections from the same fingerprint point may have different x and/or y coordinates on opposing sides of the light guide system 114. Such a difference may, for example, be caused if the reflective facets 218c (or other light-turning features of the light guide system 114) are configured to reflect the light rays 209c and 209d in opposite directions that are substantially parallel to, but not precisely parallel to, the y axis and/or configured to reflect the light rays 209a and 209b in opposite directions that are substantially parallel to, but not precisely parallel to, the x axis. In some such examples, the x coordinate of the fingerprint point from which the light reflected may be estimated by taking an average of the two x coordinates and the y coordinate of may be estimated by taking an average of the two y coordinates. According to some such examples, the average may be a weighted average. For example, the average for the x coordinates may be weighted according to the estimated y coordinate of the fingerprint point. It may be observed with reference to FIG. 4, for example, that the closer the y coordinate of the fingerprint point is to the linear array of optical sensor pixels 202c, the more likely it is that the x coordinate estimated from the linear array of optical sensor pixels 202c corresponds with the actual x coordinate of the fingerprint point.

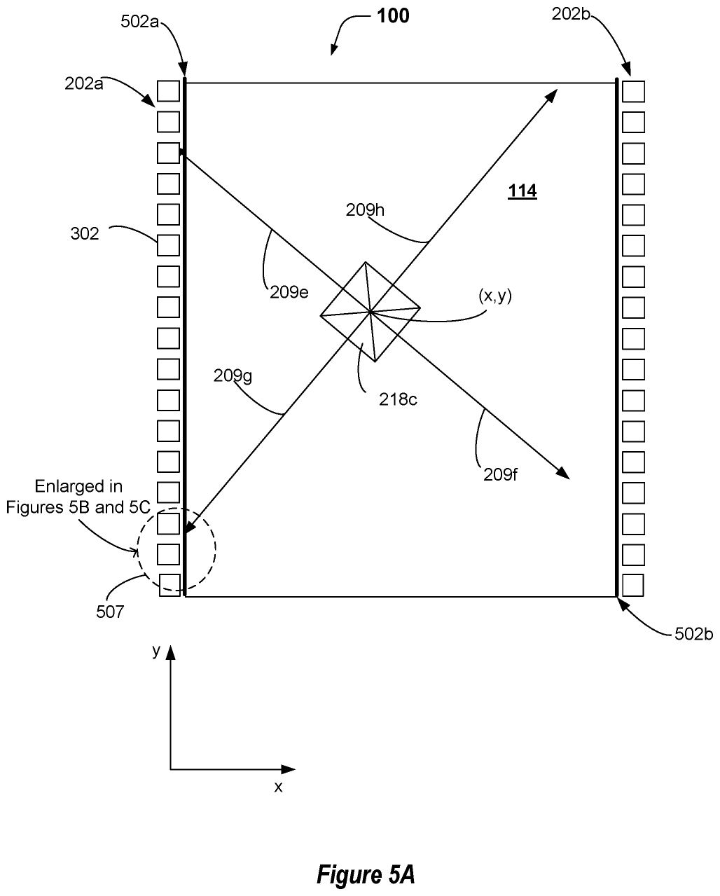

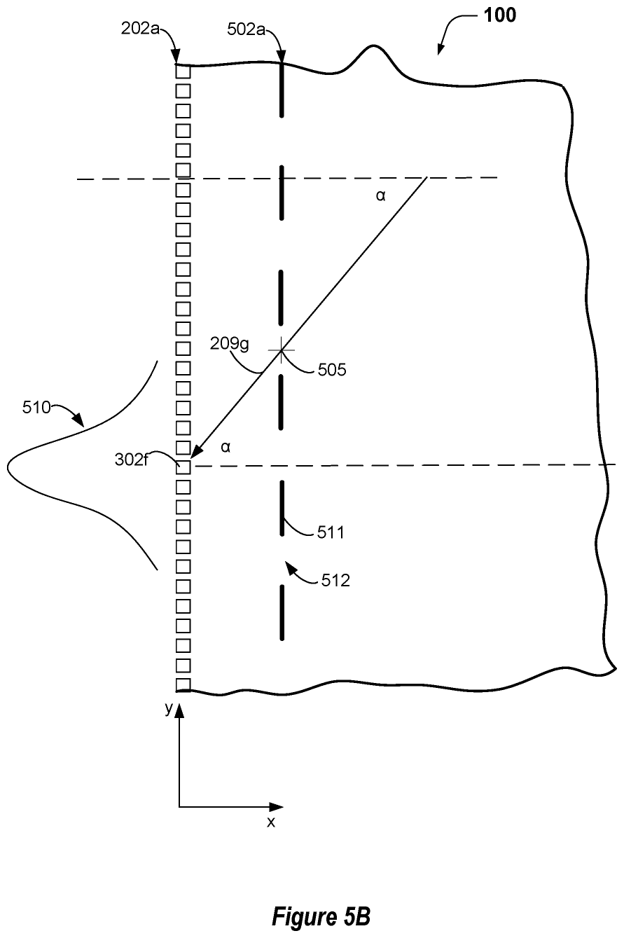

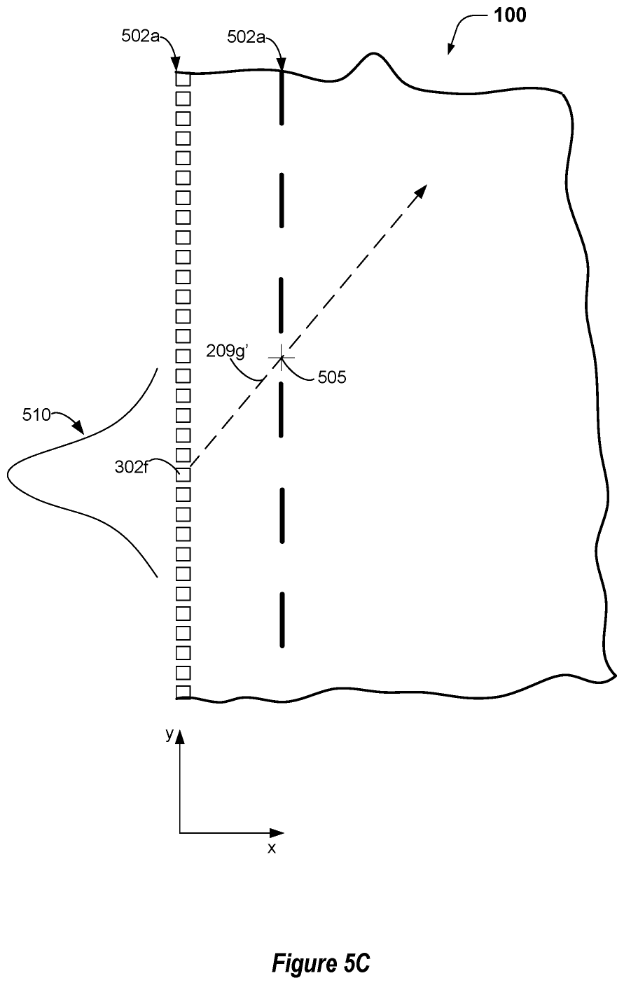

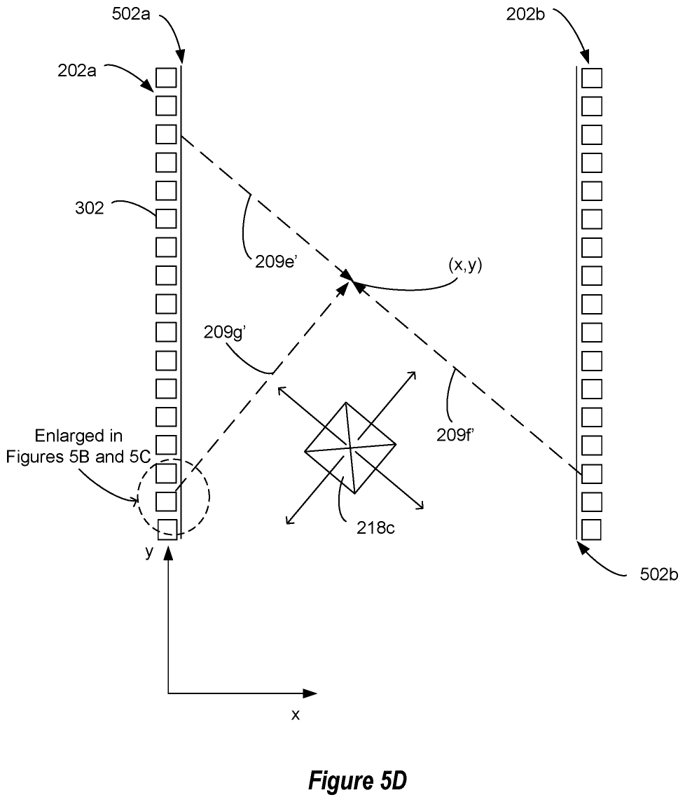

FIG. 5A shows a top view of another example of the apparatus of FIG. 2. In this example, light from a plurality of display pixels 210 has reflected or scattered from a fingerprint point (x,y), has been transmitted through one of the display stack apertures 211, has been directed by directed by the light guide system 114 and has been received by the optical sensor system 102. According to this example, the optical sensor system 102 includes the linear array of optical sensor pixels 202a along one side of the light guide system 114 and the linear array of optical sensor pixels 202b along a second and opposing side of the light guide system 114.

FIG. 5A shows some advantages of having the light guide system 114 configured to direct light in predetermined and predictable directions that are not parallel to the x and y axes. As in previous examples, the reflective facet 218c is configured to reflect the light rays 209e, 209f, 209g and 209h in directions that are orthogonal to one another. However, in this example the light rays 209e-209h are not parallel to the x and y axes. Moreover, the light rays 209e-209h are not orthogonal to the linear arrays of optical sensor pixels 202a and 202b. Accordingly, the (x,y) coordinates of the fingerprint point from which the light reflected do not direction correspond to the coordinates of the optical sensor pixels 302 that detect the light rays 209e-209h.

Some alternative examples may include a linear array of optical sensor pixels along only one side of the light guide system 114. As shown in FIG. 5A and described in more detail with reference to FIGS. 5B and 5C, such single-array implementations are feasible because the light guide system 114 is configured to direct light in directions that are not parallel to the x and y axes. In these examples, the process of correlating local intensity maxima of the optical sensor signals with fingerprint image locations involves applying a backwards propagation algorithm. According to these examples, the process of correlating local intensity maxima of the optical sensor signals with fingerprint image locations is enabled, in part, by the angular decoders 502a and 502b, which reside between the light guide system 114 and the linear arrays of optical sensor pixels 202a and 202b, respectively.

FIG. 5B is an enlarged view of a portion of FIG. 5A. The areas of the linear array of optical sensor pixels 202a and the angular decoder 502a that are shown in FIG. 5B roughly correspond to the areas of the linear array of optical sensor pixels 202a and the angular decoder 502a that are shown within the dashed circle 507 of FIG. 5A. In the enlarged view of FIG. 5B, it may be seen that in this example the angular decoder 502a includes opaque sections 511 and transparent sections 512. In this example, a control system of the apparatus 100 is configured to determine a fingerprint image based, at least in part, on a process of correlating local intensity maxima of the optical sensor signals with fingerprint image locations.

Here, the light ray 209g has passed through one of the transparent sections 512 and has been detected by the optical sensor pixel 302f and by neighboring optical sensor pixels. As noted by the graph of optical sensor signal intensity 510, the y coordinate of the optical sensor pixel 302f corresponds with a local intensity maximum of the optical sensor signals.

In this example, the process of correlating local intensity maxima of the optical sensor signals with fingerprint image locations involves applying a backwards propagation algorithm (also referred to herein as a backwards propagation method) according to transparent section locations and local intensity maxima locations corresponding to the transparent section locations. According to some examples, the backwards propagation algorithm may involve determining a point at which two or more lines intersect.

According to some implementations, the backwards propagation algorithm may be based, at least in part, on a known or assumed angle at which light rays that have passed through a transparent section 512 impinge upon the optical sensor pixels. For example, in this instance the light guide system 114 causes the light ray 209g to strike the linear array of optical sensor pixels 202a at an angle a relative to the x axis. In some examples, the backwards propagation algorithm may involve determining a first line corresponding to the light ray 209g according to the formula y=mx+b, where m represents the slope and b represents the y intercept. Such examples may be referred to herein as slope/intercept methods. In this example, the y intercept is the y coordinate of the optical sensor pixel 302f. The slope b may be determined according to the tangent of the angle α. A second line corresponding to the light ray 209e of FIG. 5a may be determined using the same method. According to some such examples, the (x,y) location of the fingerprint point is estimated to be the point at which the first line and the second line intersect. Such examples only require a single linear array of optical sensor pixels.

In some examples, a third line corresponding to the light ray 209f of FIG. 5a may be determined using a similar backwards propagation method. According to some such examples, the (x,y) location of the fingerprint point is estimated to be the point at which the first line, the second line and the third line intersect. If the point of intersection of the first line and the second line is different from the point of intersection of the second line and the third line, in some examples the x and y coordinates of the two points may be averaged in order to estimate the (x,y) location of the fingerprint point.

According to this example, the light ray 209h shown in FIG. 5A will not be detected by the linear array of optical sensor pixels 202b. Therefore, in this instance the backwards propagation method will not be based on the light ray 209h. However, in other instances a fourth line corresponding to the light ray 209h of FIG. 5a may be determined using a backwards propagation method. According to some such examples, the (x,y) location of the fingerprint point is estimated to be the point at which the first line, the second line, the third line and the fourth line intersect. If the points of intersection of any pair of lines is different from the point of intersection of any other pair of lines, in some examples the x and y coordinates of the different points of intersection may be averaged in order to estimate the (x,y) location of the fingerprint point.

In some implementations, the backwards propagation algorithm may be based, at least in part, on midpoints of the transparent sections 512. According to some such examples, the backwards propagation algorithm may be based on a line determined by (a) the coordinates of an optical sensor pixel corresponding to a local intensity maximum of optical sensor signals and (b) the location of the midpoint of a transparent section 512 through which light traveled to reach the optical sensor pixels. For example, referring to FIG. 5B, in some such examples a line may be defined by the (x,y) coordinates of the optical sensor pixel 302f and the (x,y) coordinates of the transparent section midpoint 505.

FIG. 5C shows an example of a line determined by a backwards propagation algorithm. In some examples, the dashed line 209g′ may be determined according to a slope/intercept method as described above. In other examples, the dashed line 209g′ may be determined according to a line determined by the (x,y) coordinates of the optical sensor pixel 302f and the (x,y) coordinates of the transparent section midpoint 505.

FIG. 5D shows an example of estimating a fingerprint point location according to a backwards propagation algorithm. In some examples, the dashed lines 209e′ and 209f′ may have been determined according to either of the methods described above with reference to FIGS. 5B and 5C. According to this example, the (x,y) coordinates of the fingerprint point location may be determined by the intersection of any two of the dashed lines 209e′, 209f′ and 209g′, or by the intersection of all three of the dashed lines 209e′, 209f′ and 209g′. If the points of intersection of any pair of lines is different from the point of intersection of any other pair of lines, in some examples the x and y coordinates of the different points of intersection may be averaged in order to estimate the (x,y) location of the fingerprint point. The (x,y) coordinates of other fingerprint point locations may be determined according to any of the foregoing examples.

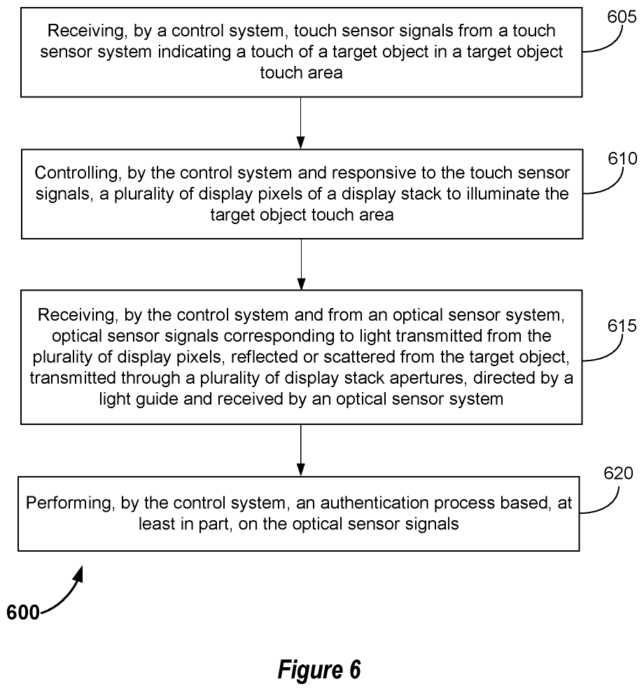

FIG. 6 is a flow diagram that provides examples of operations according to some disclosed methods. The blocks of FIG. 6 may, for example, be performed by the apparatus 100 of FIG. 1 or by a similar apparatus. As with other methods disclosed herein, the method outlined in FIG. 6 may include more or fewer blocks than indicated. Moreover, the blocks of methods disclosed herein are not necessarily performed in the order indicated. In some implementations, one or more blocks may be performed concurrently.

In this example, block 605 involves receiving, by a control system, touch sensor signals from a touch sensor system indicating a touch of a target object in a target object touch area. For example, block 605 may involve the control system 106 of FIG. 1 controlling the touch sensor system 103 to obtain touch sensor data in the target object touch area. The target object touch area may, in some instances, be the target object touch area 201 shown in FIG. 2.

According to this example, block 610 involves controlling, by the control system and responsive to the touch sensor signals, a plurality of display pixels of a display stack to illuminate the target object touch area. For example, referring again to FIG. 2, block 610 may involve the control system controlling the display pixels 210 to illuminate the target object touch area 201.

In this example, block 615 involves receiving, by the control system and from an optical sensor system, optical sensor signals corresponding to light transmitted from the plurality of display pixels, reflected or scattered from the target object, transmitted through a plurality of display stack apertures, directed by a light guide system and received by an optical sensor system. For example, referring again to FIG. 2, block 610 may involve the control system receiving light transmitted from a plurality of the display pixels 210, reflected or scattered from the target object 206, transmitted through a plurality of display stack apertures 211, directed by the light guide system 114 and received by the optical sensor system 102. Some such methods may involve collimating light transmitted through the plurality of display stack apertures 211. According to some examples, the optical sensor signals may be received from one or more linear arrays of optical sensor pixels of the optical sensor system 102. Each of the one or more linear arrays of optical sensor pixels may reside proximate a corresponding side of the light guide system 114.

In some examples, method 600 may involve determining a fingerprint image based, at least in part, on the optical sensor signals. According to some such examples, determining the fingerprint image may involve a process of correlating local intensity maxima of the optical sensor signals with fingerprint image locations. In some instances, the process of correlating local intensity maxima of the optical sensor signals with fingerprint image locations may involve applying a backwards propagation algorithm. According to some such examples, the process of correlating local intensity maxima of the optical sensor signals with fingerprint image locations may involve applying the backwards propagation algorithm according to (a) transparent section locations of an angular decoder residing between the light guide system and each of one or more linear arrays of optical sensor pixels (e.g., transparent section midpoint locations), and (b) local intensity maxima locations corresponding to the transparent section locations. In some such examples, the process of correlating local intensity maxima of the optical sensor signals with fingerprint image locations may involve applying the backwards propagation algorithm according to a slope/intercept method.

According to this example, block 620 involves performing, by the control system, an authentication process based, at least in part, on the optical sensor signals. In some such examples, block 620 may involve performing the authentication process based, at least in part, on the fingerprint image. According to some examples, method 600 may involve extracting fingerprint features from the fingerprint image. The authentication process of block 620 may involve comparing currently-obtained fingerprint features with fingerprint features obtained during an enrollment process.

Implementation examples are described in the following numbered clauses:

1. An apparatus, comprising:
a display stack residing in a display area, the display stack including display pixels and a plurality of display stack apertures;
a transparent cover proximate a first side of the display stack;
a light guide system proximate a second and opposing side of the display stack, the light guide system configured to receive light transmitted though the display stack apertures and to direct received light in two or more directions;
a touch sensor system;
an optical sensor system including one or more linear arrays of optical sensor pixels, each of the one or more linear arrays of optical sensor pixels residing proximate a corresponding side of the light guide system; and
a control system configured for communication with the touch sensor system, the optical sensor system and the display stack, the control system being further configured to:
   receive touch sensor signals from the touch sensor system indicating a touch of a target object in a target object touch area;
   control, responsive to the touch sensor signals, a plurality of display pixels to illuminate the target object touch area;
   receive, from the optical sensor system, optical sensor signals corresponding to light transmitted from the plurality of display pixels, reflected or scattered from the target object, transmitted through the display stack apertures, directed by the light guide system and received by the optical sensor system; and
   perform an authentication process based, at least in part, on the optical sensor signals.

2. The apparatus of clause 1, wherein the control system is further configured to determine a fingerprint image based, at least in part, on the optical sensor signals.

3. The apparatus of clause 2, wherein the control system is configured to determine the fingerprint image based, at least in part, on a process of correlating local intensity maxima of the optical sensor signals with fingerprint image locations.

4. The apparatus of clause 3, wherein the process of correlating local intensity maxima of the optical sensor signals with fingerprint image locations involves applying a backwards propagation algorithm.

5. The apparatus of clause 4, further comprising an angular decoder residing between the light guide system and each of the one or more linear arrays of optical sensor pixels, the angular decoder including opaque sections and transparent sections, wherein the process of correlating local intensity maxima of the optical sensor signals with fingerprint image locations involves applying the backwards propagation algorithm according to transparent section locations and local intensity maxima locations corresponding to the transparent section locations.

6. The apparatus of any one of clauses 2-5, wherein the control system is configured to extract fingerprint features from the fingerprint image and wherein the authentication process involves comparing currently-obtained fingerprint features with fingerprint features obtained during an enrollment process.

7. The apparatus of clause 6, wherein the fingerprint features include one or more of fingerprint minutiae, keypoints or sweat pores.

8. The apparatus of any one of clauses 1-7, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system opposite the first side.

9. The apparatus of clause 8, wherein the optical sensor system includes a third linear array of optical sensor pixels and a fourth linear array of optical sensor pixels, the third linear array of optical sensor pixels residing proximate a third side of the light guide system and the fourth linear array of optical sensor pixels residing proximate a fourth side of the light guide system opposite the third side.

10. The apparatus of any one of clauses 1-9, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system adjacent the first side.

11. The apparatus of any one of clauses 1-10, wherein each of the one or more linear arrays of optical sensor pixels resides proximate a corresponding side of the display area.

12. The apparatus of any one of clauses 1-11, wherein the light guide system includes one or more of a holographic volume grating configured to direct the received light in the two or more directions, a surface relief grating configured to direct the received light in the two or more directions or reflective facets configured to direct the received light in the two or more directions.

13. The apparatus of any one of clauses 1-12, wherein the plurality of display stack apertures is configured for collimating the light transmitted through the plurality of display stack apertures.

14. The apparatus of any one of clauses 1-13, wherein the display stack apertures are surrounded by light-absorbing sidewalls.

15. The apparatus of any one of clauses 1-14, wherein the plurality of display pixels includes one or more light-emitting diode pixels, one or more organic light-emitting diode pixels or one or more liquid crystal display pixels.

16. An apparatus, comprising:
a display stack residing in a display area, the display stack including display pixels and a plurality of display stack apertures;
a transparent cover proximate a first side of the display stack;
a light guide system proximate a second and opposing side of the display stack, the light guide system configured to receive light transmitted though the display stack apertures and to direct received light in two or more directions;
a touch sensor system;
an optical sensor system including one or more linear arrays of optical sensor pixels, each of the one or more linear arrays of optical sensor pixels residing proximate a corresponding side of the light guide system; and
control means for:
   receiving touch sensor signals from the touch sensor system indicating a touch of a target object in a target object touch area;
   controlling, responsive to the touch sensor signals, a plurality of display pixels to illuminate the target object touch area;
   receiving, from the optical sensor system, optical sensor signals corresponding to light transmitted from the plurality of display pixels, reflected or scattered from the target object, transmitted through the display stack apertures, directed by the light guide system and received by the optical sensor system; and
   performing an authentication process based, at least in part, on the optical sensor signals.

17. The apparatus of clause 16, wherein the control means comprises means for determining a fingerprint image based, at least in part, on the optical sensor signals.

18. The apparatus of clause 17, wherein the control means comprises means for determining the fingerprint image based, at least in part, on a process of correlating local intensity maxima of the optical sensor signals with fingerprint image locations.

19. The apparatus of clause 18, wherein the process of correlating local intensity maxima of the optical sensor signals with fingerprint image locations involves applying a backwards propagation algorithm.

20. The apparatus of clause 19, further comprising an angular decoder residing between the light guide system and each of the one or more linear arrays of optical sensor pixels, the angular decoder including opaque sections and transparent sections, wherein the process of correlating local intensity maxima of the optical sensor signals with fingerprint image locations involves applying the backwards propagation algorithm according to transparent section locations and local intensity maxima locations corresponding to the transparent section locations.

21. The apparatus of any one of clauses 17-20, wherein the control means comprises means for extracting fingerprint features from the fingerprint image and wherein the authentication process involves comparing currently-obtained fingerprint features with fingerprint features obtained during an enrollment process.

22. The apparatus of any one of clauses 16-21, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system opposite the first side.

23. The apparatus of clause 22, wherein the optical sensor system includes a third linear array of optical sensor pixels and a fourth linear array of optical sensor pixels, the third linear array of optical sensor pixels residing proximate a third side of the light guide system and the fourth linear array of optical sensor pixels residing proximate a fourth side of the light guide system opposite the third side.

24. The apparatus of any one of clauses 16-23, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system adjacent the first side.

25. The apparatus of any one of clauses 16-24, wherein each of the one or more linear arrays of optical sensor pixels resides proximate a corresponding side of the display area.

26. A method, comprising:
receiving, by a control system, touch sensor signals from a touch sensor system indicating a touch of a target object in a target object touch area;
controlling, by the control system and responsive to the touch sensor signals, a plurality of display pixels of a display stack to illuminate the target object touch area;
receiving, by the control system and from an optical sensor system, optical sensor signals corresponding to light transmitted from the plurality of display pixels, reflected or scattered from the target object, transmitted through a plurality of display stack apertures, directed by a light guide system and received by an optical sensor system; and
performing, by the control system, an authentication process based, at least in part, on the optical sensor signals.

27. The method of clause 26, wherein the light guide system receives light transmitted though the display stack apertures and directs received light in two or more directions.

28. The method of clause 27, wherein the optical sensor signals are received from one or more linear arrays of optical sensor pixels of the optical sensor system, each of the one or more linear arrays of optical sensor pixels residing proximate a corresponding side of the light guide system.

29. The method of any one of clauses 26-28, further comprising determining, by the control system, a fingerprint image based, at least in part, on the optical sensor signals.

30. The method of clause 29, wherein determining the fingerprint image involves a process of correlating local intensity maxima of the optical sensor signals with fingerprint image locations.

31. The method of clause 30, wherein the process of correlating local intensity maxima of the optical sensor signals with fingerprint image locations involves applying a backwards propagation algorithm.

32. The method of clause 31, wherein the process of correlating local intensity maxima of the optical sensor signals with fingerprint image locations involves applying the backwards propagation algorithm according to (a) transparent section locations of an angular decoder residing between the light guide system and each of one or more linear arrays of optical sensor pixels, and (b) local intensity maxima locations corresponding to the transparent section locations.

33. The method of any one of clauses 29-32, further comprising extracting fingerprint features from the fingerprint image, wherein the authentication process involves comparing currently-obtained fingerprint features with fingerprint features obtained during an enrollment process.

34. One or more non-transitory media having software recorded thereon, the software including instructions for controlling one or more devices to perform a method, the method comprising:
receiving touch sensor signals from a touch sensor system indicating a touch of a target object in a target object touch area;
controlling, responsive to the touch sensor signals, a plurality of display pixels of a display stack to illuminate the target object touch area;
receiving, from an optical sensor system, optical sensor signals corresponding to light transmitted from the plurality of display pixels, reflected or scattered from the target object, transmitted through a plurality of display stack apertures, directed by a light guide system and received by an optical sensor system; and
performing an authentication process based, at least in part, on the optical sensor signals.

35. The one or more non-transitory media of clause 34, wherein the method further comprises determining a fingerprint image based, at least in part, on the optical sensor signals.

36. The one or more non-transitory media of clause 35, wherein determining the fingerprint image involves a process of correlating local intensity maxima of the optical sensor signals with fingerprint image locations.

37. The one or more non-transitory media of clause 36, wherein the process of correlating local intensity maxima of the optical sensor signals with fingerprint image locations involves applying a backwards propagation algorithm.

38. The one or more non-transitory media of clause 37, wherein the process of correlating local intensity maxima of the optical sensor signals with fingerprint image locations involves applying the backwards propagation algorithm according to (a) transparent section locations of an angular decoder residing between the light guide system and each of one or more linear arrays of optical sensor pixels, and (b) local intensity maxima locations corresponding to the transparent section locations.

39. The one or more non-transitory media of any one of clauses 35-38, wherein the method further comprises extracting fingerprint features from the fingerprint image, wherein the authentication process involves comparing currently-obtained fingerprint features with fingerprint features obtained during an enrollment process.

40. The one or more non-transitory media of any one of clauses 34-39, wherein the method further comprises collimating light transmitted through the plurality of display stack apertures. As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

1. An apparatus, comprising:
a display stack residing in a display area, the display stack including display pixels and a plurality of display stack apertures, the plurality of display stack apertures being configured for collimating light transmitted through the plurality of display stack apertures;
a transparent cover proximate a first side of the display stack;
a light guide system proximate a second and opposing side of the display stack, the light guide system configured to receive collimated light transmitted through the display stack apertures and to direct received collimated light in two or more directions;
a touch sensor system;
an optical sensor system including one or more linear arrays of optical sensor pixels, each of the one or more linear arrays of optical sensor pixels residing proximate a corresponding side of the light guide system; and
a control system configured for communication with the touch sensor system, the optical sensor system and the display stack, the control system being further configured to:
receive touch sensor signals from the touch sensor system indicating a touch of a target object in a target object touch area;
control, responsive to the touch sensor signals, a plurality of display pixels to illuminate the target object touch area;
receive, from the optical sensor system, optical sensor signals corresponding to light transmitted from the plurality of display pixels, reflected or scattered from the target object, transmitted through the display stack apertures, directed by the light guide system and received by the optical sensor system; and
perform an authentication process based, at least in part, on the optical sensor signals.

2. The apparatus of claim 1, wherein the control system is further configured to determine a fingerprint image based, at least in part, on the optical sensor signals.

3. The apparatus of claim 2, wherein the control system is configured to determine the fingerprint image based, at least in part, on a process of correlating local intensity maxima of the optical sensor signals with fingerprint image locations.

4. The apparatus of claim 3, wherein the process of correlating local intensity maxima of the optical sensor signals with fingerprint image locations involves applying a backwards propagation algorithm.

5. The apparatus of claim 4, further comprising an angular decoder residing between the light guide system and each of the one or more linear arrays of optical sensor pixels, the angular decoder including opaque sections and transparent sections, wherein the process of correlating local intensity maxima of the optical sensor signals with fingerprint image locations involves applying the backwards propagation algorithm according to transparent section locations and local intensity maxima locations corresponding to the transparent section locations.

6. The apparatus of claim 2, wherein the control system is configured to extract fingerprint features from the fingerprint image and wherein the authentication process involves comparing currently-obtained fingerprint features with fingerprint features obtained during an enrollment process.

7. The apparatus of claim 6, wherein the fingerprint features include one or more of fingerprint minutiae, keypoints or sweat pores.

8. The apparatus of claim 1, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system opposite the first side.

9. The apparatus of claim 8, wherein the optical sensor system includes a third linear array of optical sensor pixels and a fourth linear array of optical sensor pixels, the third linear array of optical sensor pixels residing proximate a third side of the light guide system and the fourth linear array of optical sensor pixels residing proximate a fourth side of the light guide system opposite the third side.

10. The apparatus of claim 1, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system adjacent the first side.

11. The apparatus of claim 1, wherein each of the one or more linear arrays of optical sensor pixels resides proximate a corresponding side of the display area.

12. The apparatus of claim 1, wherein the light guide system includes one or more of a holographic volume grating configured to direct the received light in the two or more directions, a surface relief grating configured to direct the received light in the two or more directions or reflective facets configured to direct the received light in the two or more directions.

13. (canceled)

14. The apparatus of claim 1, wherein the display stack apertures are surrounded by light-absorbing sidewalls.

15. The apparatus of claim 1, wherein the plurality of display pixels includes one or more light-emitting diode pixels, one or more organic light-emitting diode pixels or one or more liquid crystal display pixels.

16. An apparatus, comprising:
a display stack residing in a display area, the display stack including display pixels and a plurality of display stack apertures having light-absorbing sidewalls;
a transparent cover proximate a first side of the display stack;
a light guide system proximate a second and opposing side of the display stack, the light guide system configured to receive light transmitted through the display stack apertures and to direct received light in two or more directions;
a touch sensor system;
an optical sensor system including one or more linear arrays of optical sensor pixels, each of the one or more linear arrays of optical sensor pixels residing proximate a corresponding side of the light guide system; and
control means for:
receiving touch sensor signals from the touch sensor system indicating a touch of a target object in a target object touch area;
controlling, responsive to the touch sensor signals, a plurality of display pixels to illuminate the target object touch area;
receiving, from the optical sensor system, optical sensor signals corresponding to light transmitted from the plurality of display pixels, reflected or scattered from the target object, transmitted through the display stack apertures, directed by the light guide system and received by the optical sensor system; and
performing an authentication process based, at least in part, on the optical sensor signals.

17. The apparatus of claim 16, wherein the control means comprises means for determining a fingerprint image based, at least in part, on the optical sensor signals.

18. The apparatus of claim 17, wherein the control means comprises means for determining the fingerprint image based, at least in part, on a process of correlating local intensity maxima of the optical sensor signals with fingerprint image locations.

19. The apparatus of claim 18, wherein the process of correlating local intensity maxima of the optical sensor signals with fingerprint image locations involves applying a backwards propagation algorithm.

20. The apparatus of claim 19, further comprising an angular decoder residing between the light guide system and each of the one or more linear arrays of optical sensor pixels, the angular decoder including opaque sections and transparent sections, wherein the process of correlating local intensity maxima of the optical sensor signals with fingerprint image locations involves applying the backwards propagation algorithm according to transparent section locations and local intensity maxima locations corresponding to the transparent section locations.

21. The apparatus of claim 17, wherein the control means comprises means for extracting fingerprint features from the fingerprint image and wherein the authentication process involves comparing currently-obtained fingerprint features with fingerprint features obtained during an enrollment process.

22. The apparatus of claim 16, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system opposite the first side.

23. The apparatus of claim 22, wherein the optical sensor system includes a third linear array of optical sensor pixels and a fourth linear array of optical sensor pixels, the third linear array of optical sensor pixels residing proximate a third side of the light guide system and the fourth linear array of optical sensor pixels residing proximate a fourth side of the light guide system opposite the third side.

24. The apparatus of claim 16, wherein the optical sensor system includes a first linear array of optical sensor pixels and a second linear array of optical sensor pixels, the first linear array of optical sensor pixels residing proximate a first side of the light guide system and the second linear array of optical sensor pixels residing proximate a second side of the light guide system adjacent the first side.

25. The apparatus of claim 16, wherein each of the one or more linear arrays of optical sensor pixels resides proximate a corresponding side of the display area.

26. A method, comprising:
receiving, by a control system, touch sensor signals from a touch sensor system indicating a touch of a target object in a target object touch area;
controlling, by the control system and responsive to the touch sensor signals, a plurality of display pixels of a display stack to illuminate the target object touch area;
receiving, by the control system and from an optical sensor system, optical sensor signals corresponding to light transmitted from the plurality of display pixels, reflected or scattered from the target object, transmitted through a plurality of display stack apertures, directed by a light guide system and received by an optical sensor system, the plurality of display stack apertures being configured for collimating light transmitted through the plurality of display stack apertures; and
performing, by the control system, an authentication process based, at least in part, on the optical sensor signals.

27. The method of claim 26, wherein the light guide system receives collimated light transmitted through the display stack apertures and directs received collimated light in two or more directions.

28. The method of claim 27, wherein the optical sensor signals are received from one or more linear arrays of optical sensor pixels of the optical sensor system, each of the one or more linear arrays of optical sensor pixels residing proximate a corresponding side of the light guide system.

29. The method of claim 26, further comprising determining, by the control system, a fingerprint image based, at least in part, on the optical sensor signals.

30. The method of claim 29, wherein determining the fingerprint image involves a process of correlating local intensity maxima of the optical sensor signals with fingerprint image locations.

31. The method of claim 30, wherein the process of correlating local intensity maxima of the optical sensor signals with fingerprint image locations involves applying a backwards propagation algorithm.

32. The method of claim 31, wherein the process of correlating local intensity maxima of the optical sensor signals with fingerprint image locations involves applying the backwards propagation algorithm according to (a) transparent section locations of an angular decoder residing between the light guide system and each of one or more linear arrays of optical sensor pixels, and (b) local intensity maxima locations corresponding to the transparent section locations.

33. The method of claim 29, further comprising extracting fingerprint features from the fingerprint image, wherein the authentication process involves comparing currently-obtained fingerprint features with fingerprint features obtained during an enrollment process.

34. One or more non-transitory media having software recorded thereon, the software including instructions for controlling one or more devices to perform a method, the method comprising:
receiving touch sensor signals from a touch sensor system indicating a touch of a target object in a target object touch area;
controlling, responsive to the touch sensor signals, a plurality of display pixels of a display stack to illuminate the target object touch area;
receiving, from an optical sensor system, optical sensor signals corresponding to light transmitted from the plurality of display pixels, reflected or scattered from the target object, transmitted through a plurality of display stack apertures, directed by a light guide system and received by an optical sensor system, the plurality of display stack apertures being configured for collimating light transmitted through the plurality of display stack apertures; and
performing an authentication process based, at least in part, on the optical sensor signals.

35. The one or more non-transitory media of claim 34, wherein the method further comprises determining a fingerprint image based, at least in part, on the optical sensor signals.

36. The one or more non-transitory media of claim 35, wherein determining the fingerprint image involves a process of correlating local intensity maxima of the optical sensor signals with fingerprint image locations.

37. The one or more non-transitory media of claim 36, wherein the process of correlating local intensity maxima of the optical sensor signals with fingerprint image locations involves applying a backwards propagation algorithm.

38. The one or more non-transitory media of claim 37, wherein the process of correlating local intensity maxima of the optical sensor signals with fingerprint image locations involves applying the backwards propagation algorithm according to (a) transparent section locations of an angular decoder residing between the light guide system and each of one or more linear arrays of optical sensor pixels, and (b) local intensity maxima locations corresponding to the transparent section locations.

39. The one or more non-transitory media of claim 35, wherein the method further comprises extracting fingerprint features from the fingerprint image, wherein the authentication process involves comparing currently-obtained fingerprint features with fingerprint features obtained during an enrollment process.

40. (canceled)
